(19) United States
(12) Patent Application Publication
(10) Pub. No.: US 2026/0024380 A1
(43) Pub. Date: Jan. 22, 2026

(54) TRANSFER STATIONS AND METHODS FOR TRANSFERRING AUTONOMOUS VEHICLE SENSOR DATA TO A REMOTE DATA STORAGE SERVER

(71) Applicant: Torc Robotics, Inc., Blacksburg, VA (US)

(72) Inventors: Joseph Nottingham, Aldie, VA (US); Matthew Edward Green, Blacksburg, VA (US); Justin Brown, Lynchburg, VA (US)

(21) Appl. No.: 18/775,525

(22) Filed: Jul. 17, 2024

(51) Int. Cl. G07C 5/00; G06F 1/18; G06F 21/44; G11B 20/00

(52) U.S. Cl. CPC G07C 5/008; G06F 1/187; G06F 21/44; G11B 20/00224

(57) ABSTRACT

A transfer station for receiving a plurality of removable storage devices storing autonomous vehicle sensor data and transferring the data to a remote data storage server includes a plurality of bays and a computing system. Each bay includes a port, and can receive a removable storage device. The computing system includes memory storing an authentication and decryption engine, a physical server node, and a processor in communication with the memory, physical server node, and each port of each bay. The processer decrypts a removable storage device upon connection to a port, authenticates the removable storage device upon decryption, and transfers the autonomous vehicle sensor data stored on the removable storage device to a remote data storage server upon authentication, each of which can be performed automatically. A method of transferring autonomous vehicle sensor data stored on a removable storage device to a remote data storage server is also provided.

### TECHNICAL FIELD

The present disclosure relates generally to the field of autonomous vehicle sensor data management. More specifically, the present disclosure relates to transfer stations and methods for transferring autonomous vehicle sensor data to a remote data storage server.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies generally use sensors like a camera, a radio detection and ranging (RADAR) sensor, a light detection and ranging (LiDAR) sensor for detecting the surrounding environment of the autonomous vehicle, and the like. In addition to being used by the perception technologies, the data generated by these sensors, as well as vehicle system data, is used for the development and testing of autonomous vehicle platforms. The first step to enabling organizational use of the sensor and system data is to make it accessible by transferring the data to a remote system for analysis. However, the sensors can generate several terabytes of data per hour depending on the fidelity of the data being generated, e.g., if high fidelity uncompressed images are being recording, which can complicate the data transfer process. In particular, due to the large volume of heterogeneous sensor and system data, it is often not practical to wirelessly transfer the sensor data stored on the vehicle's computer system to an off-board system due to the significant amount of time that would be required.

Accordingly, in order to efficiently transfer the data, operators may have to remove the entire computer from the vehicle and connect it to a different computer system that is separate from the vehicle for uploading. This process requires technical knowledge of how to remove the computer system from the vehicle, how to connect the systems, how to initiate and perform a file transfer, and how to reconnect the computer to the vehicle, etc. Moreover, this process may still result in significant vehicle downtime. Additionally, the operator runs the risk of accidentally damaging the vehicle's computer system during the transfer process.

Accordingly, there exists a need for systems and methods for transferring sensor data from an autonomous vehicle to a remote system that addresses the foregoing and other issues.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to transfer stations and methods for transferring autonomous vehicle sensor data to a remote data storage server.

In accordance with aspects of the present disclosure, a transfer station for receiving a plurality of removable storage devices storing autonomous vehicle sensor data and transferring the autonomous vehicle sensor data to a remote data storage server is provided. The transfer station includes a plurality of bays and a computing system. Each of the plurality of bays includes a port, and is configured to receive a removable storage device storing autonomous vehicle sensor data. The computing system includes memory storing an authentication and decryption engine, a physical server node, and a processor in communication with the memory, the physical server node, and the port of each of the plurality of bays. The process decrypts a removable storage device using the authentication and decryption engine upon connection of the removable storage device to a port of one of the plurality of bays, authenticates the removable storage device using the authentication and decryption engine upon decryption of the removable storage device, and transfers the autonomous vehicle sensor data stored on the removable storage device to a remote data storage server upon authenticating the removable storage device.

In some aspects, the processor can transfer autonomous vehicle sensor data stored on each of a plurality of removable storage devices to the remote data storage server simultaneously upon decrypting and authenticating each of the plurality of removable storage devices.

In some other aspects, the processor can decrypt the removable storage device using a master key that is capable of decrypting a plurality of removable storage devices each having a different encryption key. In such aspects, the master key can be received by the computing system from a remote management system.

In still other aspects, the processor can authenticate the provenance of the autonomous vehicle sensor data stored on the removable storage device.

In other aspects, the processor can automatically delete the autonomous vehicle sensor data stored on the removable storage device upon confirming that all desired autonomous vehicle sensor data has been transferred to the remote data storage server.

In some other aspects, the processor can generate a manifest of desired files to be transferred from the removable storage device to the remote data storage server.

In still other aspects, the autonomous vehicle sensor data can include a plurality of packets and each of the plurality of packets can have a respective topic associated therewith. In such aspects, the processor can restrict the transferring of at least a portion of the autonomous vehicle sensor data from the removable storage device to the remote data storage server based on topic and/or the processor can prioritize the transfer of the autonomous vehicle sensor data from the removable storage device to the remote data storage server based on topic.

In some other aspects, information relating to the transfer of the autonomous vehicle sensor data from the removable storage device to the remote data storage server including a status of the transfer can be accessible by the computing system via a web interface.

In still other aspects, the processor can automatically decrypt the removable storage device using the authentication and decryption engine upon connection of the removable storage device to a port of one of the plurality of bays, automatically authenticate the removable storage device using the authentication and decryption engine upon decryption of the removable storage device, and automatically transfer the autonomous vehicle sensor data stored on the removable storage device to a remote data storage server upon authenticating the removable storage device.

A method of transferring autonomous vehicle sensor data stored on a removable storage device to a remote data storage server is provided. The method involves receiving a removable storage device containing autonomous vehicle sensor data in a bay of a transfer station, and determining that the removable storage device is in communication with a computing system of the transfer station via a port of the bay. The method also involves decrypting the removable storage device using an authentication and decryption engine of the computing system upon determining that the removable storage device is in communication with the computing system and authenticating the removable storage device using the authentication and decryption engine upon decrypting the removable storage device. The method further involves transferring the autonomous vehicle sensor data stored on the removable storage device to a remote data storage server upon authenticating the removable storage device.

In some aspects, the method can include receiving a second removable storage device containing second autonomous vehicle sensor data in a second bay of the transfer station and determining that the second removable storage device is in communication with the computing system via a second port of the second bay. Such methods can also involve decrypting the second removable storage device using the authentication and decryption engine upon determining that the second removable storage device is in communication with the computing system and authenticating the second removable storage device using the authentication and decryption engine upon decryption of the second removable storage device. Such methods can further involve transferring the second autonomous vehicle sensor data stored on the second removable storage device to the remote data storage server upon authenticating the second removable storage device. In such methods, the autonomous vehicle sensor data and the second autonomous vehicle sensor data can be transferred to the remote data storage server simultaneously.

In other aspects, the operation of decrypting the removable storage device can include decrypting the removable storage device using a master key that is capable of decrypting a plurality of removable storage devices each having a different encryption key. Such methods can also involve receiving the master key at the computing system from a remote management source.

In some other aspects, the process of authenticating the removable storage device includes can include authenticating the provenance of the autonomous vehicle sensor data stored on the removable storage device.

In still other aspects, the method can include confirming that all desired autonomous vehicle sensor data has been transferred to the remote data storage server and automatically deleting the autonomous vehicle sensor data stored on the removable storage device upon confirming that all desired autonomous vehicle sensor data has been transferred to the remote data storage server.

In some other aspects, the method can include generating a manifest of desired files to be transferred from the removable storage device to the remote data storage server, generating an index of files transferred from the removable storage device to the remote data storage server, and determining a transfer progress based on at least the manifest and the index.

In still other aspects, the method can involve restricting the transferring of at least a portion of the autonomous vehicle sensor data from the removable storage device to the remote data storage server based on one or more topics associated with the autonomous vehicle sensor data and/or prioritizing the transferring of at least a portion of the autonomous vehicle sensor data from the removable storage device to the remote data storage server based on one or more topics associated with the autonomous vehicle sensor data.

In other aspects, the method can involve displaying information relating to the transfer of the autonomous vehicle sensor data from the removable storage device to the remote data storage server including a status of the transfer.

In still other aspects, the method can involve removing the removable storage device from a port of an autonomous vehicle, inserting the removable storage device into the bay of the transfer station, and connecting a port of the removable storage device with the port of the bay.

In some other aspects, decrypting the removable storage device using an authentication and decryption engine of the computing system can be performed automatically upon determining that the removable storage device is in communication with the computing system, authenticating the removable storage device using the authentication and decryption engine can be performed automatically upon decrypting the removable storage device, and transferring the autonomous vehicle sensor data stored on the removable storage device to the remote data storage server can be performed automatically upon authenticating the removable storage device.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is a schematic view of an autonomous vehicle of the present disclosure;

FIG. 2 is a block diagram of the autonomous vehicle shown in FIG. 1;

FIG. 3 is a block diagram of an example computing system of the present disclosure;

FIG. 4 is a block diagram of an example removable storage device of the present disclosure;

FIG. 5 is a block diagram of an example transfer system including an example transfer station of the present disclosure;

FIG. 6 is a front view of an example transfer site of the present disclosure;

FIG. 7A is a front view of a transfer station having two empty removable storage device bays;

FIG. 7B is a front view of the transfer station of FIG. 7A having a removable storage device inserted into one of the removable storage device bays;

FIG. 8 is a diagram of an example transfer system of the present disclosure;

FIG. 9 is a flowchart illustrating exemplary operations performed for transferring data from a removable storage device to a remote storage server according to the present disclosure;

FIG. 10A illustrates an exemplary user interface; and

FIG. 10B illustrates a portion of the exemplary user interface of FIG. 10B showing that all transfers have been completed.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

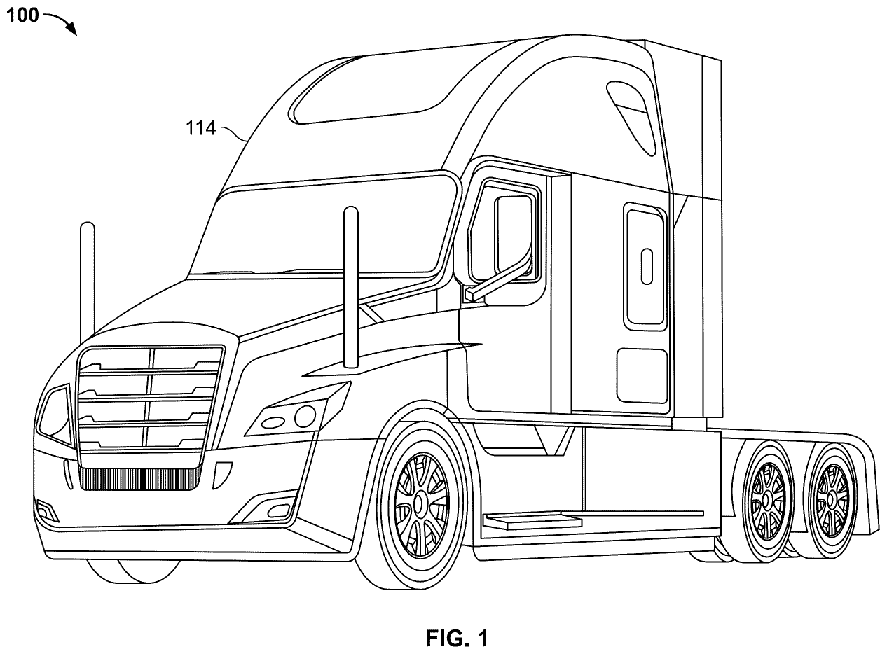

The present disclosure relates to systems and methods for transferring autonomous vehicle sensor data to a remote data storage server, as described in detail below in connection with FIGS. 1-10B.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

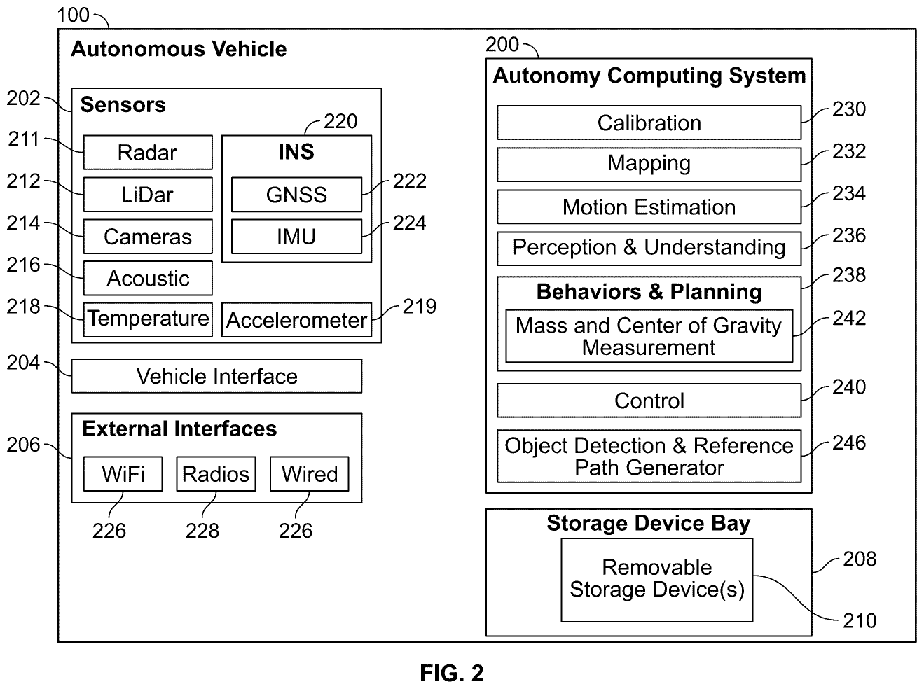

The vehicle 100 may be an autonomous vehicle, in which case the vehicle 100 may omit the steering wheel and the steering column to steer the vehicle 100. Rather, the vehicle 100 may be operated by an autonomy computing system 200 (see FIG. 2) of the vehicle 100 based on data collected by a sensor network including one or more sensors, e.g., sensors 202 shown in FIG. 2.

FIG. 2 is a block diagram of autonomous vehicle 100 shown in FIG. 1. In the example embodiment, the autonomous vehicle 100 includes an autonomy computing system 200, sensors 202, a vehicle interface 204, external interfaces 206, and a storage device bay 208, which can receive one or more removable storage devices 210.

In the example embodiment, the sensors 202 may include various sensors such as, for example, radio detection and ranging (RADAR) sensors 211, light detection and ranging (LiDAR) sensors 212, cameras 214, acoustic sensors 216, temperature sensors 218, accelerometers 219, and/or an inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound, microphones, etc.), internal vehicle sensors, meteorological sensors, a hygrometer, a rain gauge, or other types of sensors. The sensors 202 can be positioned in various locations on the vehicle 100. For example, the sensors 202 can be positioned on the side of the vehicle 100, on the front bumper of the vehicle 100, on mirrors of the vehicle 100, in the cab of the vehicle 100, on the top of the vehicle 100, etc. The sensors 202 generate respective output signals based on detected physical conditions of the autonomous vehicle 100 and its proximity. As described in further detail below, these signals may be used by autonomy computing system 200 to determine how to control operations of the autonomous vehicle 100. Additionally, the data generated by the sensors 202, along with system data, can be stored on a removable storage device 210 that is inserted into the storage device bay 208 for upload to a remote storage server, as discussed in greater detail below.

Cameras 214 are configured to capture images of the environment surrounding autonomous vehicle 100 in any aspect or field of view (FOV). The FOV can have any angle or aspect such that images of the areas ahead of, to the side, behind, above, or below the autonomous vehicle 100 may be captured. In some embodiments, the FOV may be limited to particular areas around the autonomous vehicle 100 (e.g., forward of autonomous vehicle 100, to the sides of the autonomous vehicle 100, etc.) or may surround 360 degrees of the autonomous vehicle 100. In some embodiments, the autonomous vehicle 100 includes multiple cameras 214, and the images from each of the multiple cameras 214 may be processed to identify one or more construction markers or other objects in the environment surrounding the autonomous vehicle 100. In some embodiments, the image data generated by the cameras 214 may be sent to the autonomy computing system 200 or other aspects of the autonomous vehicle 100 or a hub or both, including to a removable storage device 210 that is inserted into the storage device bay 208.

LiDAR sensors 212 generally include a laser generator and a detector that send and receive a LiDAR signal such that LiDAR point clouds (or “LiDAR images”) of the areas ahead of, to the side, behind, above, or below the autonomous vehicle 100 can be captured and represented in the LiDAR point clouds. RADAR sensors 211 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from the cameras 214, RADAR sensors 211, or LiDAR sensors 212 may be used in combination to identify one or more construction markers (or nodes) around the autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 225 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway. In some aspects, the wired external interface 206 could be provided as the storage device bay 208 such that the removable storage device 210 is connected to the wired interface 226.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

The mass and center of gravity measurement module 242 may perform one or more tasks including, but not limited to, receiving data corresponding to the total mass and the center of gravity of autonomous vehicle 100 with a trailer loaded with goods. Data corresponding to the total mass and the center of gravity may be based on measurements performed at a hub, while autonomous vehicle 100, is in a parked position, using multiple image sensors (or cameras) mounted or positioned at the hub. Additionally, or alternatively, data corresponding to the total mass and the center of gravity may be based on measurements performed at the hub using multiple weight sensors (e.g., strain gage-based sensors) positioned at the hub to measure force or weight applied at multiple measurement points (e.g., at each wheel of autonomous vehicle 100 and a connected trailer).

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

The storage device bay 208 can be provided as a slot in the interior of the cabin 114 that is configured to receive one or more removable storage devices 210 therein. Alternatively, the storage device bay 208 can be provided as a slot that extends into the exterior of the cabin 114 with an all-weather cover, such that the storage device bay 208 and any removable storage devices 210 inserted therein are externally accessible. The storage device bay 208 can include a physical connector or port, e.g., wired interface 226, that is communicatively coupled to the autonomy computing system 200 and/or the sensors 202. Accordingly, when a removable storage device 210 is inserted into the storage device bay 208 the physical connector or port communicatively couples the removable storage device 210 to the autonomy computing system 200 and/or the sensors 202 such that data obtained by the sensors 202 is transferred to and stored on the removable storage device 210. The removable storage device(s) 210 can be removed from the storage device bay 208 by an operator once they arrive at a transfer station or hub in order to upload the data stored thereon to a remote data storage server, e.g., a data lake, data warehouse, cloud server, etc., as described in greater detail below. Additionally, the storage device bay 208 can be keyed such that a removable storage device 210 can be inserted into the storage device bay 208 in only one configuration to ensure connection of the removable storage device 210 with the physical connectors or ports of the storage device bay 208.

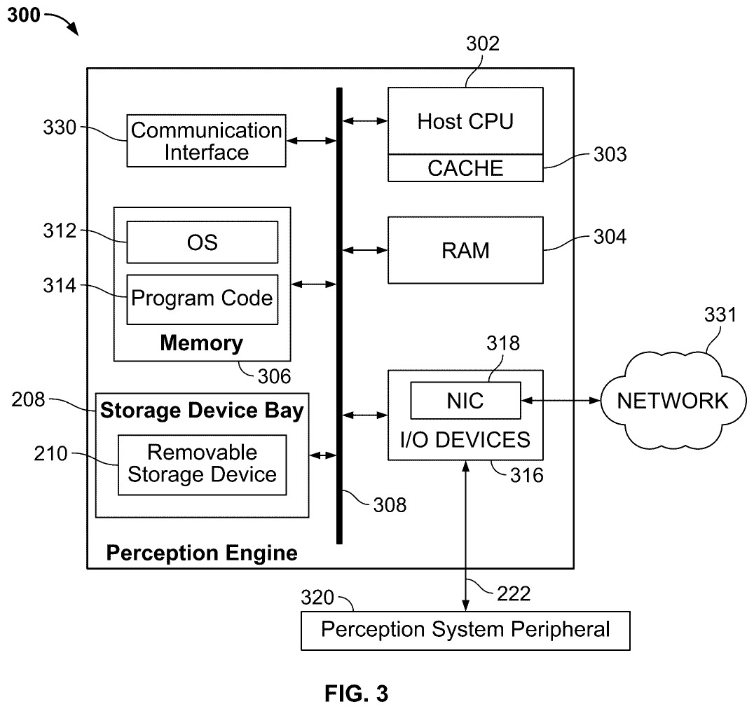

FIG. 3 is a block diagram of an example computing system 300, such as the autonomy computing system 200 shown in FIG. 2, configured for sensing an environment in which the autonomous vehicle 100 is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. Program code 314 may also contain one or more modules for provisioning a removable storage device 210, linking the removable storage device 210 with the particular vehicle 100, and/or confirming that a removable storage device 210 inserted into the storage device bay 208 is authorized to be connected to the vehicle 100. In alternative embodiments, one or more sections of memory 306 may be omitted and the data stored remotely. For example, in certain embodiments, program code 314 may be stored remotely on a server or mass-storage device and made available over a network 331 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus. Additionally, the storage device bay 208 and associated removable storage device 210 can be in communication with the host CPU 302 via the bus 308 such that the host CPU can control the transfer of data to the removable storage device 210, as well as provisioning and authentication thereof.

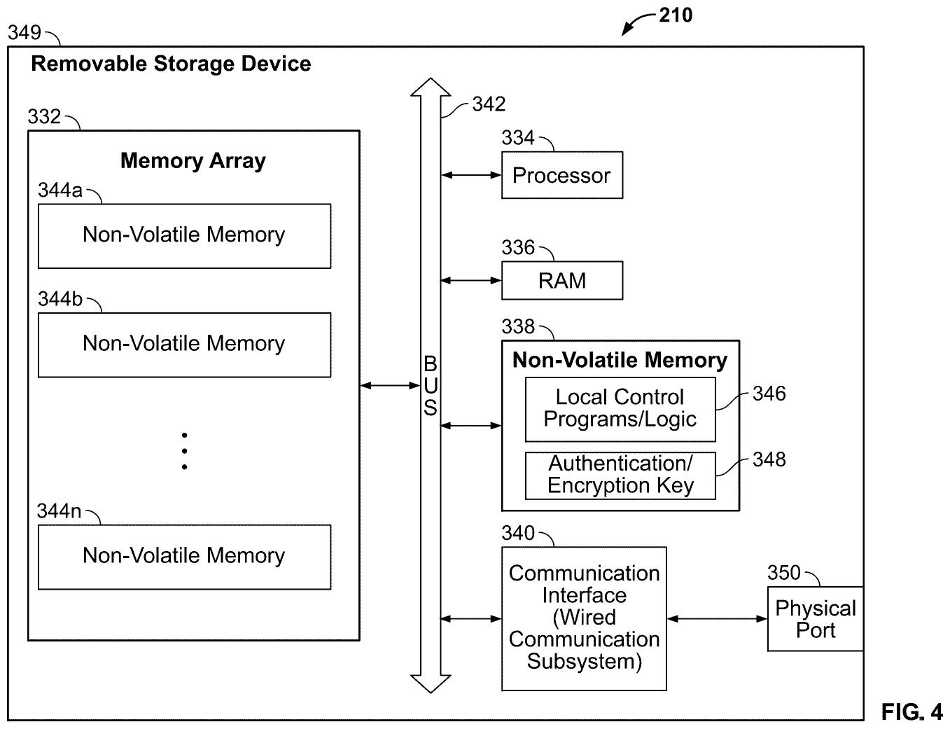

FIG. 4 is a block diagram of an example removable storage device 210 illustrating components thereof in greater detail. The removable storage device 210 is configured to be connected to the autonomous vehicle 100 via the storage device bay 208, and have sensor data and system data written thereto during operation of the autonomous vehicle 100. The removable storage device 210 includes a memory array 332, a processor 334, random-access memory (RAM) 336, non-volatile memory 338, and a communication interface 340, e.g., an NIC, connected via a bus 342. The memory array 332 includes a plurality of non-volatile memories 344a, 344b, 344n, which can be provided as hard disks or solid-state drives, arranged in a redundant array of independent disks (RAID) configuration, e.g., RAID 0, RAID 1, RAID 2, RAID 3, RAID 4, RAID 5, RAID 6, etc. The processor 334 can be a disk array controller that is configured to manage the plurality of non-volatile memories 344a-n and the storage of data on the plurality of non-volatile memories 344a-n.

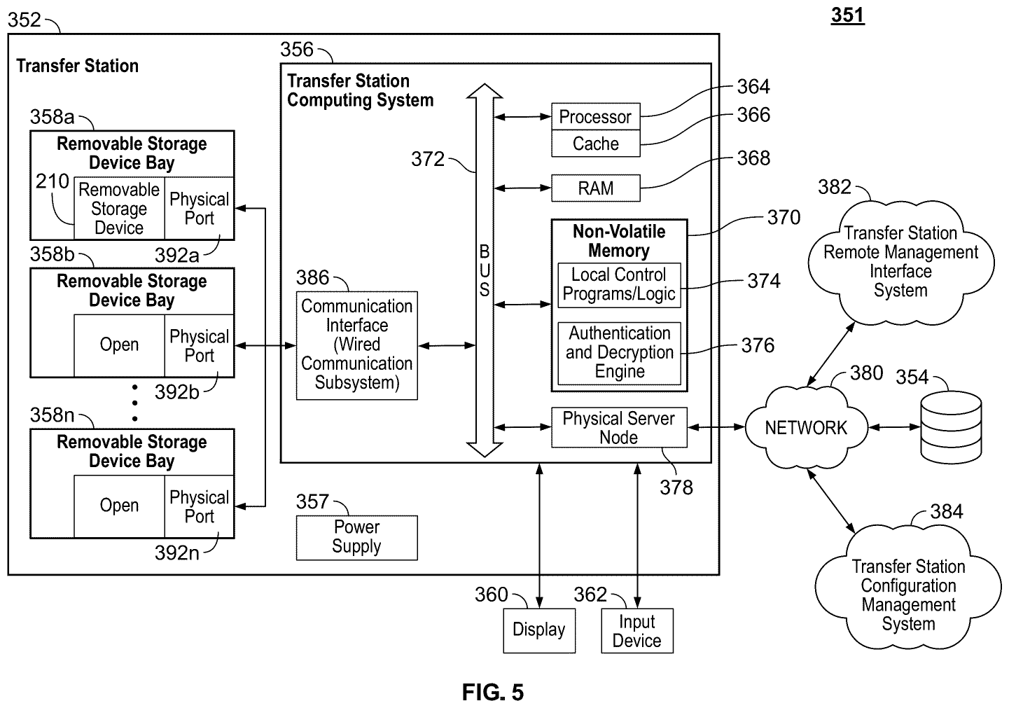

The RAM 336 and non-volatile memory 338 are configured to operate in combination with the processor 334, with the processor 334 providing local processing capability for the removable storage device 210. In this regard, the non-volatile memory 338 can store one or more local control programs/logic 346, which can include program code, for providing local control and management of the memory array 332, and an authentication/encryption key 348 that can be used to encrypt the data stored on the memory array 332 and authenticate the removable storage device 208 with the autonomous computing system 200 and/or a transfer station 352 (see FIG. 5). The authentication/encryption key 348 allows for only authentic removable storage devices 208 to be used with the autonomous vehicle 100 and only authorized devices, e.g., transfer stations 352, to access the data stored on the removable storage device 210. The communication interface 340 can be a wired communication subsystem that can include, for example, an Ethernet transceiver or a serial transceiver that supports one or more suitable communication protocols, e.g., Ethernet, RS-485, RS-232, USB, etc. The communication interface 340 allows for bidirectional data communications between the removable storage device 210 and the autonomous vehicle 100, e.g., the computing system 200 and/or the sensors 202 of the autonomous vehicle 100, via the physical port 350, which can be communicatively connected to the wired interface 226 of the autonomous vehicle 100 when the removable storage device 210 is inserted into the storage device bay 208. Similarly, the communication interface 340 allows for bidirectional data communications between the removable storage device 210 and the transfer station 352, as discussed in greater detail below.

The various components of the removable storage device 210 can be provided in a ruggedized enclosure 349. The ruggedized enclosure 349 protects the components from being damaged during insertion of the removable storage device 210 into the storage device bay 208, removal of the removable storage device 210 from the storage device bay 208, transfer of the removable storage device 210 to a transfer station 352, and insertion of the removable storage device 210 into the transfer station 352.

FIG. 5 is a block diagram of an example transfer system 351 including an example transfer station 352 that receives one or more removable storage devices 210, decrypts the received removable storage device 210, authenticates the decrypted removable storage device 210, and transfers the data stored thereon to a remote data storage server 354, e.g., a storage lake, storage warehouse, cloud server, etc., which can be performed automatically, e.g., without requiring operator input or instruction. In this regard, the transfer station 352 is provided as a rack mountable edge compute device that is optimized for the bulk transfer of data, e.g., sensor data, from the removable storage devices 210. The transfer station 352 includes a transfer station computing system 356, a power supply 357, and one or more removable storage device bays 358a-n. The transfer station 352 can be connected to an optional display 360 and an optional input device 362.

The computing system 356 includes a processor 364 coupled to a cache memory 366, and further coupled to RAM 368 and NV memory 370 via a memory bus 372. Cache memory 366 and RAM 368 are configured to operate in combination with processor 364. NV memory 370 is a computer-readable memory that includes at least a memory section storing local control programs/logic 374, and an authentication and decryption engine 376. The local control programs/logic 374 can include an OS and program code, and can be configured to control the automatic and simultaneous transfer of data from removable storage devices 210 that are connected to or otherwise interfaced with the transfer station 352 to the remote data storage server 354. The authentication and decryption engine 376 can be implemented by the processor 364 to automatically decrypt a removable storage device 210 that is connected to the transfer station 352 using a master key, which can be stored locally on the NV memory 370 or transmitted thereto, and authenticate the connected removable storage device 210.

The transfer station computing system 356 can include a physical server node 378, e.g., physical network node, in communication with the bus 372. The physical server node 378 can be a modem, router, hub, etc., that is in communication with a network 380, e.g., the Internet, over which the transfer station computing system 356 can communicate with a transfer station remote management interface system 382, a transfer station configuration management system 384, and the remote data storage server 354. The physical server node 378 is optimized for storage and network throughput to support the simultaneous transfer of data from multiple removable storage devices 210 connected to the transfer station 352 to the remote data storage sever 354. For example, the physical server node 378 can include multiple network cards capable of uploading multiple gigabytes of data per second.

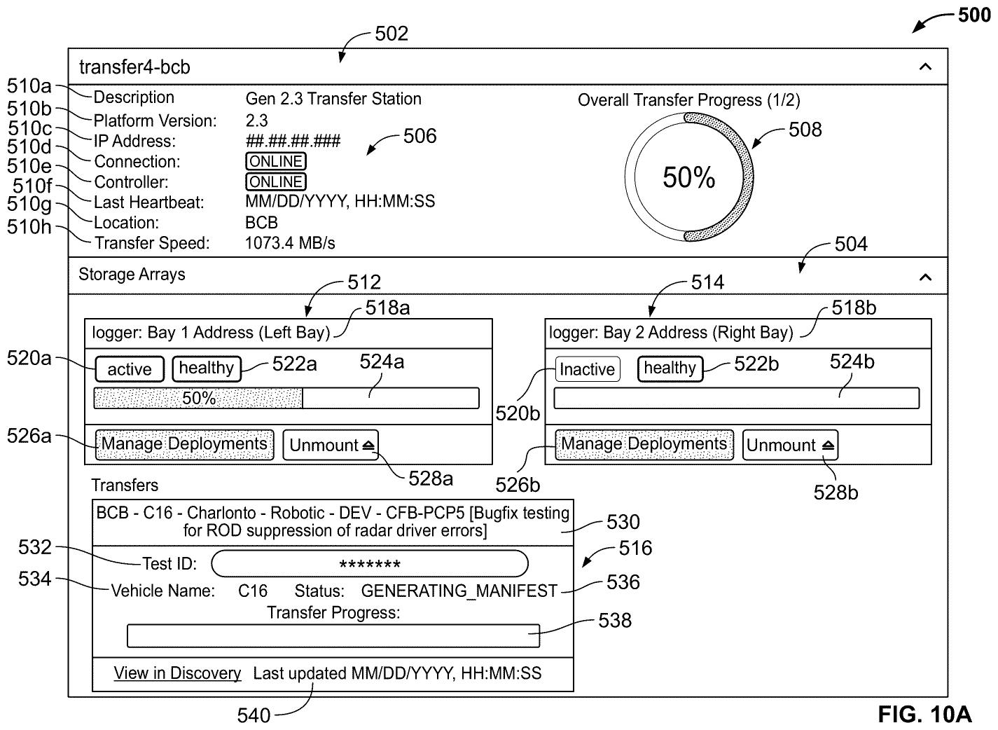

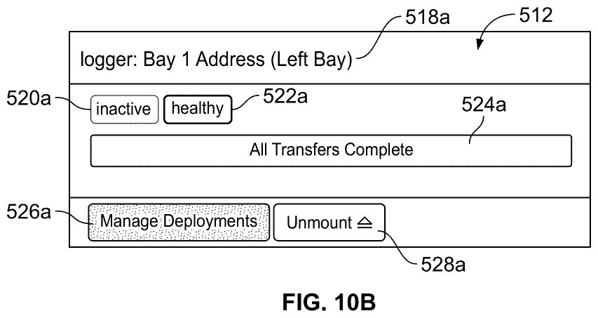

The transfer station remote management interface system 382 can be accessed by an operator using the display 360 and input device 362 connected with the transfer station 352, and provides a user interface 500 (see FIG. 10) showing information regarding the transfer station 352, the removable storage device 210, and the data transfer, e.g., the data transfer progress, transfer speed, IP address, connection status, notifications, etc. The user interface 500 can automatically refresh after a predetermined period of time, e.g., every 10 seconds. The transfer station remote management interface system 382 can also be used to maintain removable storage devices 210 and provision new removable storage devices 210.

The transfer station configuration management system 384 can store a decryption master key password, which can be provided to a transfer station 352 on-demand to decrypt a removable storage device 210 when connected thereto. The transfer station configuration management system 384 can also store restricted data topics and data topic priority lists, which can be used to control what files are transferred from the removable storage device 210 to the remote data storage server 354 and in what order the files are transferred.

The transfer station computing system 356 also includes a communication interface 386, which can be a wired communication subsystem that can include, for example, an Ethernet transceiver or a serial transceiver that supports one or more suitable communication protocols, e.g., Ethernet, RS-485, RS-232, USB, etc. The communication interface 386 allows for bidirectional data communications between the removable storage devices 210 connected to the transfer station 352 and the transfer station computing system 356. In this regard, the transfer station 352 includes a plurality of removable storage device bays 358a, 358b, 358n that each have a physical port 392a, 392b, 392n associated therewith. Each of the physical ports 392a, 392b, 392n are communicatively connected to the communication interface 386.

The removable storage device bays 358a-n are sized and configured to receive a removable storage device 210 therein. When a removable storage device 210 is fully inserted into the removable storage device bay 358a-n, the physical port 350 of the removable storage device 210 connects with the physical port 392a-n of the respective removable storage device bay 358a-n placing the removable storage device 210 in communication with the transfer station computing system 356. The processor 364 of the transfer station computing system 356 automatically performs a series of operations upon detecting that a removable storage device 210 has been inserted into one of the removable storage device bays 358a-n and connected to the physical port 392a-n. In particular, the processor 364 automatically authenticates the removable storage device 210, decrypts the removable storage device 210, and transfers the data stored on the removable storage device 210 to the remote data storage server 354 without requiring operator instruction, as discussed in greater detail below. Accordingly, the removable storage devices 210 are hot-swappable devices that can be inserted into any removable storage device bay 358a-n of a transfer station 352 that is powered on without first shutting down the transfer station 352.

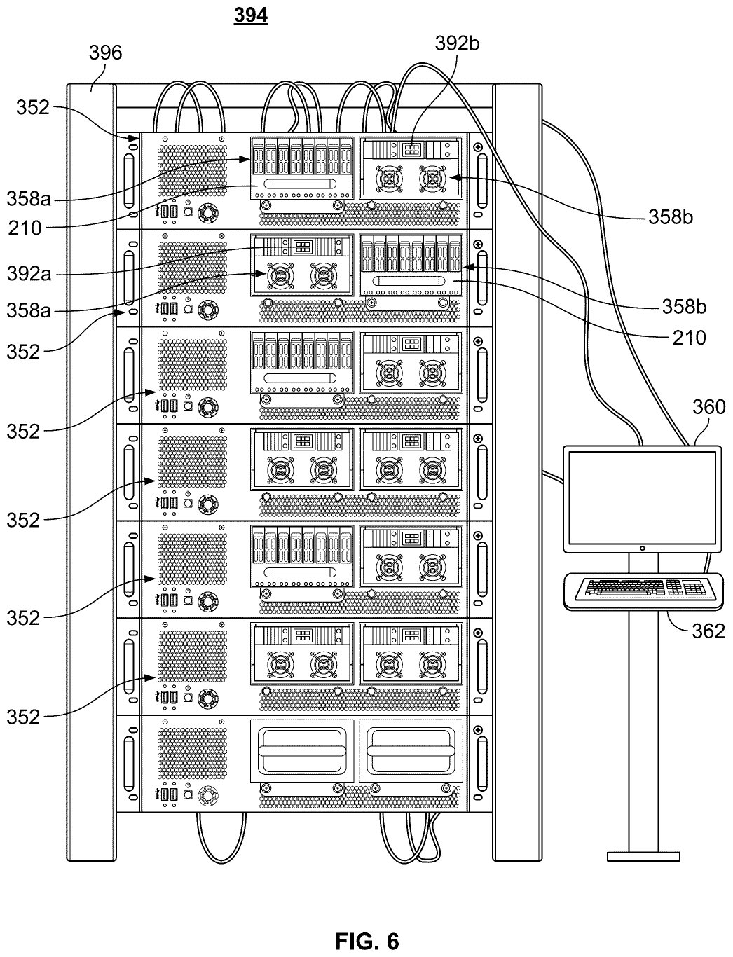

FIG. 6 is a front view of an exemplary transfer site 394 having a plurality of exemplary transfer stations 352 mounted to a rack 396. Each of the plurality of transfer stations 352 shown in FIG. 6 includes two removable storage device bays 358a, 358b that are configured to receive a removable storage device 210. In this regard, the uppermost transfer station 352 is shown as having a removable storage device 210 inserted into the first removable storage device bay 358a thereof, while the second removable storage device bay 358b thereof is empty.

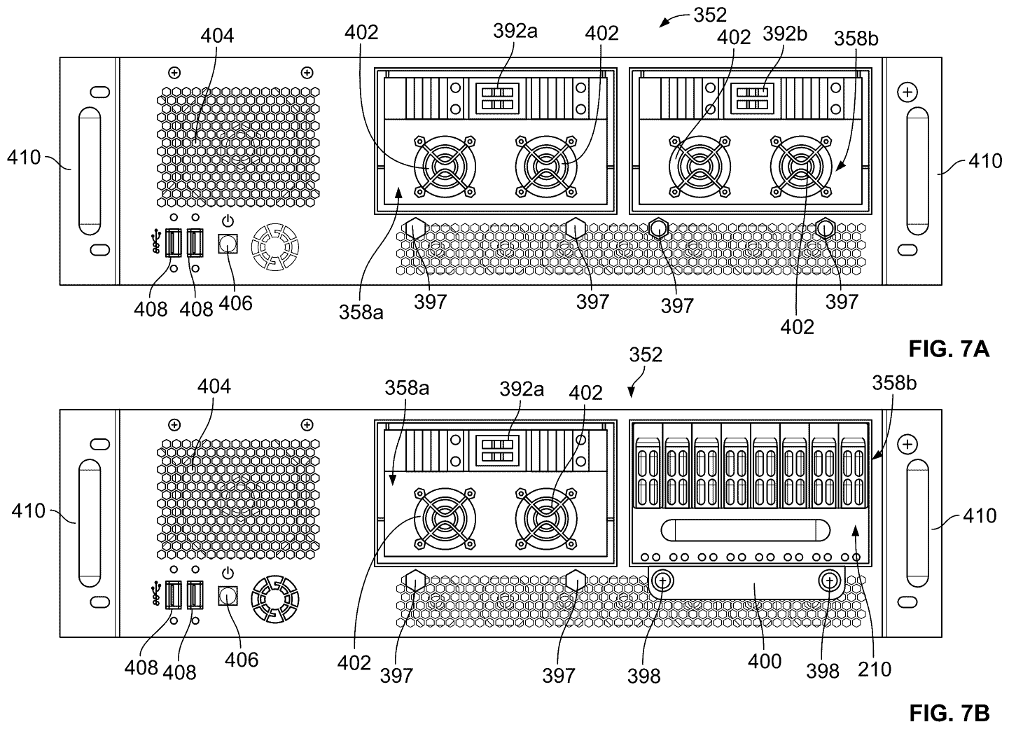

FIG. 7A is a front view of a transfer station 352 having two empty removable storage device bays 358a, 358b, while FIG. 7B is a front view of the transfer station 352 of FIG. 7A having a removable storage device 210 inserted into the second removable storage device bay 358b thereof. As noted in connection with FIGS. 5 and 6, the transfer station 352 includes two removable storage device bays 358a, 358b that each have a physical port 392a, 392b associated therewith. The removable storage device bays 358a, 358b can be keyed so that removable storage devices 210 can be inserted into the removable storage device bays 358a, 358b in only one configuration to ensure connection of the respective physical ports 350, 392a, 392b. In this regard, the physical port 392a, 392b can be positioned in a rear wall of the removable storage device bays 358a, 358b so that the physical port 350 of a removable storage device 210 interfaces therewith when the removable storage device 210 is fully inserted in the removable storage device bay 358a, 358b.

The transfer station 352 can also include a plurality of threaded holes 397 that are configured to threadedly receive a bolt 398, which can extend through a flange 400 of the removable storage device 210. The bolts 398 can be used to properly seat and secure the removable storage devices 210 within the removable storage device bays 358a, 358b to ensure that the physical ports 350, 392a, 392b are properly engaged and prevent inadvertent removal of the removable storage device 210 prior to completion of the data transfer process. Each of the removable storage device bays 358a, 358b can also include one or more fans 402 that can assist with cooling the removable storage devices 210 during data transfer. Similarly, the transfer station 352 can include a fan 404 that cools the processor 364 and other components of the transfer station computing system 356. The transfer station 352 can additionally include a power button 406 that is used to power on and off the transfer station 352, as well as a plurality of wired external interfaces 408, e.g., USB ports, that allow for data exchange with the transfer station 352. For example, firmware upgrades can be provided to the transfer station via the wired external interfaces 408. The transfer station 352 is a modular component that can be mounted to and removed from the rack 396 (FIG. 6), as needed. Accordingly, each transfer site 394 can be expanded by adding additional transfer stations 352 to the rack 396. Each transfer station 352 can be provided with handles 410 to facilitate handling thereof.

The transfer station 352 is configured to perform a data offloading process upon insertion of a removable storage device 210 into a powered removable storage bay 358a, 358b, 358n and connection of the respective physical ports 350, 392a, 392b. In this regard, the data offloading process can be performed automatically by the transfer station 352. In particular, the computing system 356 of the respective data transfer station 352 automatically recognizes the connected removable storage device 210 and begins the data transfer process by first decrypting the connected removable storage device 210, e.g., using the authentication and decryption engine 376 and a master key. The master key can be provided to the data transfer station 352 by the transfer station configuration management system 384, and can be used to decrypt all provisioned removable storage devices 210 that have a unique encryption key. Upon decrypting the removable storage device 210, the computing system 356 authenticates the removable storage device 210. In this regard, the removable storage device 210 can have metadata stored thereon that contains an identity of the removable storage device 210. This identify can link the removable storage device 210 to a particular vehicle 100. Additionally, during the authentication phase, the transfer station 352 verifies the provenance of the data stored on the removable storage device 210 to ensure that not only is the removable storage device 210 authentic, but also that the data stored thereon is authentic. Once the removable storage device 210 has been decrypted and authenticated, the transfer station 352 transfers the data, e.g., the raw data in its compressed (binary) format, stored on the removable storage device 210 to the remote data storage server 354 over a high-speed connection. The remote data storage server 354 can unpack each data package into the proper format based on metadata associated therewith, e.g., camera frame format, tabular format, etc., as it is uploaded and index all of the unpacked data for future analysis.

During the data transfer process, the transfer station 352 communicates with the transfer station configuration management system 384 to verify that all desired files are transferred to the remote data storage server 354 and confirm the integrity of the transferred data. In particular, the transfer station 352 generates a manifest that describes all files to be transferred, including a checksum associated with each file. The manifest can be based at least in part on the file system structure of the removable storage device 210. As the files are uploaded to the remote data storage server 354, the transfer station configuration management system 384 sends checksum data back to the transfer station 352 for the files that have been uploaded, and the transfer station 352 compares the received checksums for the uploaded files to those contained within the manifest to validate the files that were received by the remote data storage server 354, e.g., confirm that they are not corrupt. Additionally, the transfer station configuration management system 384 builds an index of ingested data as the files are uploaded thereto and compares the index to the manifest to confirm that all desired data has been received. Accordingly, the transfer station 352 performs an integrity check of the uploaded files based on checksums, and confirms that all files have been transferred by recursively reviewing and paring down the manifest. Notably, this process allows for a plurality of files to be transferred simultaneously, as opposed to being uploaded one at a time. Once the transfer station configuration management system 384 confirms that all files have been safely uploaded it issues a purge signal to the transfer station 352, which, upon receiving the purge signal, deletes all sensor data stored on the memory array 332 of the removable storage device 210. The empty removable storage device 210 can then be removed by an operator and immediately returned to, and reused in, the vehicle 100 for which the removable storage device 210 is provisioned. It is noted that the foregoing operations and procedures can be performed simultaneously for multiple removable storage devices 210 connected to individual bays 358a, 358b, 358n of the transfer station 352.

Moreover, during the data transfer process, the transfer station configuration management system 384 can perform topic enforcement to ensure that privacy sensitive data is not ingested into the remote data storage server 354, e.g., when operating in regions with laws preventing the distribution of particular data. In particular, all data recorded to the removable storage devices 210 can be segmented by topic, e.g., radar data, LiDar data, images, videos, sound recordings, temperature data, etc., based on file type and prior to transferring the files, the data recorded on the removable storage device 210 can be compared against a list of restricted topics maintained by the transfer station configuration management system 384. Any packet of data that is categorized with a restricted topic is prevented from being uploaded and ingested into the remote data storage server 354. For example, if a removable storage device 210 is connected to a transfer station 352 located in a jurisdiction that does not allow for the collection of images, then all packets of data categorized with an image topic or a video topic are prevented from being uploaded and ingested into the remote data storage server 354. Topic enforcement and data transfer restriction can be based, for example, on the location of the transfer station 352. The foregoing functionality facilitates compliance with regional data collection rules by enforcing sensitive data restrictions at the edge device, e.g., transfer station 352, prior to data transfer. It should be understood that the transfer station configuration management system 384 could be a remote system or a local system provided as a software module of the transfer station 352. Accordingly, the transfer station 352 could include a list of restricted topics stored thereon and locally perform the foregoing topic enforcement functionality.

Additionally, the transfer of data can be prioritized based on data topics in order to reduce the time-to-availability of high-priority data at the remote data storage server 354 and/or reduce the volume of transmitted data by preliminarily analyzing the data stored on the removable storage device 210. For example, the data recorded on the removable storage device 210 can be compared against a prioritized list of topics maintained by the transfer station configuration management system 384, and transferred to the remote data storage server 354 based on the priority of their respective topic. In this regard, the transfer station configuration management system 384 can order the transfer of data from the transfer station 352 to the remote data storage server 354 based the prioritized topic list so that (a) data is transferred in the order of priority, and/or (b) only data having a topic that is on the priority list is transferred and topics that are not on the priority list are not transferred from the removable storage device 210.

Furthermore, as previously noted, the transfer station remote management interface system 382 can be accessed by an operator using the display 360 and input device 362 connected with the transfer station 352, and provides an auto-updating user interface 500 (see FIG. 10) that shows information pertaining to the transfer station 352, the removable storage device 210, and the data transfer, e.g., the data transfer progress, transfer speed, IP address, connection status, notifications, etc. The user interface 500 (see FIG. 10) can notify the operator when the transfer process is complete and prompt the operator to remove the removable storage device 210 and return it to the associated vehicle 100. The transfer station remote management interface system 382 can also be used to maintain removable storage devices 210, e.g., repair a configuration of the memory array 332, and provision removable storage devices 210 for use with a new vehicle 100, e.g., disassociate an encryption key that is currently associated with a removable storage device 210 so that the removable storage device 210 can be used in a different vehicle 100 that can provision the removable storage device 210 with a new encryption key that is linked to that new vehicle 100. Accordingly, the transfer station remote management interface system 382 provides an intuitive user interface 500 on the cloud platform that allows operators, e.g., fleet managers and analysts, to seamlessly access, visualize, and manage removable storage devices 210 and the transfer process.

By providing the removable storage devices 210 as encrypted hot-swappable storage canisters, the transfer stations 352 can decrypt a large number of removable storage devices 210 without sharing the master key with the data logging source, e.g., the vehicle 100, which also provides for authentication of the data, as discussed above.

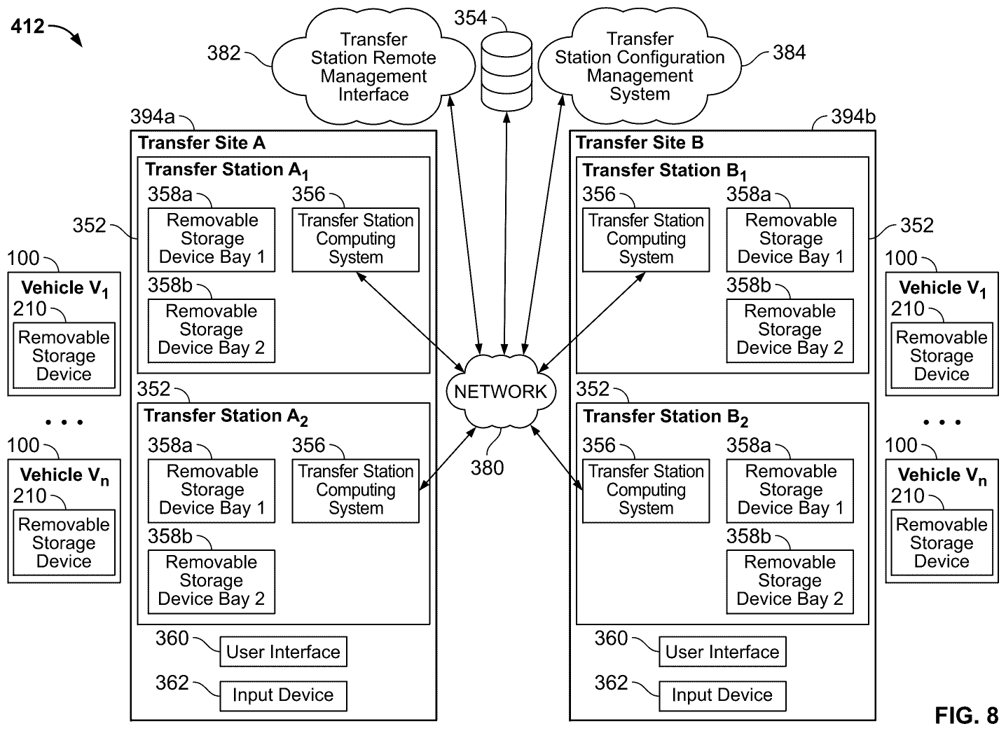

FIG. 8 is a diagram of an example transfer system 412 that includes a plurality of transfer sites 394a, 394b that can each include a plurality of transfer stations 352 in communication with the transfer station remote management interface system 382, the transfer station configuration management system 384, and the remote data storage server 354 via the network 380. Each of the transfer sites 394a, 394b can be similar in construction and functionality to the transfer site 394 shown and described in connection with FIG. 6, and it should be understood that the description thereof applies to transfer sites 394a and 394b.

The transfer sites 394a, 394b can be arranged at different geographic locations and configured such that multiple vehicles 100 can pull into each transfer site 394a, 394a in order to upload the data, e.g., sensor data and system data, stored on respective removable storage devices 210. In this regard, after pulling into a transfer site 394a, 394b, an operator can remove the removable storage device(s) 210 from the vehicle 100 and insert each removable storage device 210 into a removable storage device bay 358a, 358b in order to have the data stored thereon automatically uploaded to the remote data storage server 354. Each of the transfer sites A and B 394a, 394b shown in FIG. 8 have two transfer stations 352 that each have two removable storage bays 358a, 358b; however, it should be understood that each of the transfer sites A and B 394a, 394b could have more than two transfer stations 352, e.g., 3, 4, 5, etc., and each of the transfer stations 352 could have more than two removable storage bays 358a, 358b, e.g., 3, 4, 5, etc.

Accordingly, transfer stations 352 can be deployed across multiple transfer sites 394a, 394b to scale transfer capabilities with the growth of an autonomous vehicle 100 fleet.

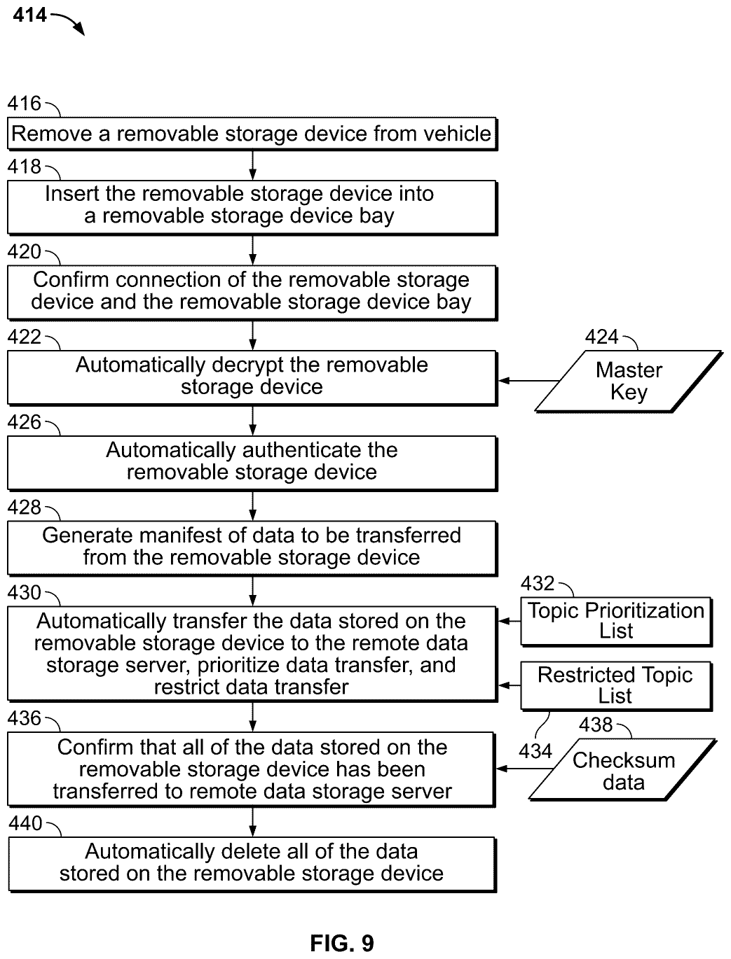

FIG. 9 is a flowchart 414 illustrating exemplary operations performed for transferring data from a removable storage device 210 to a remote storage server 354 according to the present disclosure. In 416, an operator physically removes the removable storage device 210 from the vehicle 100. In 418, the operator physically inserts the removable storage device 210 into an open/unoccupied removable storage device bay 358a, 358b, 358n of a transfer station 352 such that the physical ports 350, 392a, 392b are connected. As discussed in connection with FIGS. 7A and 7B, the operator can insert bolts 398 through the flange 400 of the removable storage device 210 and threadedly engage the bolts 398 with threaded holes 397 to properly seat and secure the removable storage device 210 within the removable storage device bays 358a, 358b to ensure that the physical ports 350, 392a, 392b are properly engaged and prevent inadvertent removal of the removable storage device 210 prior to completion of the data transfer process.

In 420, the transfer station computing system 356 confirms, or otherwise acknowledges, connection of the port 350 of the removable storage device 210 to the port 392a, 392b, 392n of the removable storage device bay 358a, 358b, 358n, and proceeds to automatically decrypt the connected removable storage device 210 in 422. In this regard, the computing system 356 can decrypt the storage device 210 using the authentication and decryption engine 376, or other software disk controller component running on the transfer station 352, and a master key 424 that is retrieved from secrets storage and decrypted to allow the storage device 210 to be opened. The master key 424 can be provided to the computing system 356 by the transfer station configuration management system 384 or stored locally on the computing system 356. Once the storage device 210 is decrypted, the process 414 proceeds to 426 in which the computing system 356 automatically authenticates the storage device 210. In this regard, the computing system 356, using the authentication and decryption engine 376 or other software stored thereon, analyzes metadata of the storage device 210 to confirm the identify thereof and verifies the provenance of the data stored on the storage device 210.

In 428, a manifest of the data to be transferred from the storage device 210 to the remote data storage server 354 is generated. The manifest describes all files to be transferred, including a checksum associated with each file. In 430, the computing system 356 begins to transfer the data stored on the storage device 210 to the remote data storage server 354. The transfer of data can be prioritized based on data topics in order to reduce the time-to-availability of high-priority data at the remote data storage server 354 and/or reduce the volume of transmitted data by preliminarily analyzing the data stored on the removable storage device 210 prior to transfer. For example, the data recorded on the removable storage device 210 can be compared against a topic prioritization list 432 maintained by the transfer station configuration management system 384, and transferred to the remote data storage server 354 in order of topic priority. In this regard, the transfer station configuration management system 384 can order the transfer of data from the transfer station 352 to the remote data storage server 354 based the topic prioritization list 432 so that (a) data is transferred in the order of priority, and/or (b) only data having a topic that is on the priority list is transferred and topics that are not on the priority list are not transferred from the storage device 210 to the remote data storage server 354. Additionally, during the transfer process, but prior to transferring a particular data packet, the transfer station configuration management system 384 can perform topic enforcement to ensure that privacy sensitive data is not ingested into the remote data storage server 354 by comparing the data stored on the storage device 210 to a restricted topic list 434. That is, any packet of data that is categorized with a topic from the restricted topic list 434 is prevented from being uploaded and ingested into the remote data storage server 354. The restricted topic list 434 can be maintained by the transfer station configuration management system 384 or the transfer station 352.

In 436, the system confirms that all desired data stored on the storage device 210 has been transferred to the remote data storage server 354. In particular, the transfer station configuration management system 384 builds an index of ingested data as the files are uploaded thereto and compares the index to the manifest generated in 428 to confirm that all desired data has been received. Additionally, as the files are uploaded to the remote data storage server 354, the transfer station configuration management system 384 sends checksum data 438 back to the transfer station 352 for the files that have been uploaded, and the transfer station 352 compares the received checksum data 438 for the uploaded files to those contained within the manifest to validate the files that were received by the remote data storage server 354, e.g., confirm that they are not corrupt. Accordingly, the transfer station 352 performs an integrity check of the uploaded files based on checksums, while the transfer station configuration management system 384 confirms that all data has been transferred. In 440, after it is confirmed that all the data has been transferred, the transfer station configuration management system 384 issues a purge signal to the transfer station 352, which, upon receiving the purge signal, deletes all sensor data stored on the memory array 332 of the removable storage device 210. The empty removable storage device 210 can then be removed by an operator and immediately returned to, and reused in, the vehicle 100 for which the removable storage device 210 is provisioned.

It is noted that the process 414 shown and described in connection with FIG. 9 can be performed simultaneously for multiple removable storage devices 210 as the removable storage devices 210 are connected to individual bays 358a, 358b, 358n of the transfer station 352.

FIG. 10A illustrates an exemplary user interface 500 that can be provided and displayed to a user on a display 360 at a transfer site 394 by accessing the transfer station remote management interface system 382. The user interface 500 displays information regarding the transfer station 352, the removable storage device 210, and any current data transfer taking place. In particular, the user interface 500 includes a transfer station information section 502 and a storage array section 504. The transfer station information section 502 includes general information 506 pertaining to the transfer station 352 along with an overall transfer progress indicator 508. The general information 506 displayed for the transfer station 352 can include a description 510a, the current platform version 510b, the IP address 510c, the connection status 510d, the controller status 510e, the last heartbeat 510f (e.g., the time of the last status update), the transfer station location 510g, and the current transfer speed 510h. The general information 506 allows a user to quickly identify characteristics of the transfer station 352 including whether the transfer station 352 is online and transferring data, or offline. The transfer progress indicator 508 can show the current overall transfer progress as a percentage for all storage device bays 208 of the transfer station 352. In this regard, the transfer progress indicator 508 illustrates what percentage of the data from all removable storage devices 210 connected to the transfer station 352 has been transferred to the remote data storage server 354.

The storage array section 504 can include a first storage device bay region 512, a second storage device bay region 514, and a connected removable storage device region 516. Each of the first and second storage device bay regions 512, 514 can include a storage device bay address bar 518a, 518b, an active/inactive status indicator 520a, 520b, a health status indicator 522a, 522b, a local transfer progress indicator 524a, 524b, a manage deployments button 526a, 526b, and an unmount button 528a, 528b. As can be seen in FIG. 10A, the first bay is active, e.g., a removable storage device 210 is inserted into the first bay and connected thereto, and the second bay is inactive, as per the active/inactive status indicators 520a, 520b. The manage deployments buttons 526a, 526b can be used to manage the removable storage device 210 connected thereto, e.g., for partioning or repairing a connected removable storage device 210. The unmount button 528a, 528b can be selected to deactivate the connected removable storage device 210 allowing it to be safely removed from the bay. In this regard, once the file transfer process has been completed for a removable storage device 210, e.g., all files have been transferred from removable storage device 210 to the remote data storage server 354 and the transfer station 352 has deleted all data on the removable storage device 210, the local transfer progress indicator 524a, 524b will display that all of the transfers are complete, which will prompt a user to unmount and remove the removable storage device 210, as shown in FIG. 10B. The connected removable storage device region 516 can display information pertaining to the removable storage device 210 currently connected to the respective bay, including, but not limited to, a heading bar 530, which can include the name of the removable storage device 210, a test ID 532, the vehicle name 534 to which the removable storage device 210 is provisioned, a file transfer status 536 (e.g., the current file transfer operation being performed), a transfer progress indicator 538, and update information 540 (e.g., information pertaining to when the removable storage device 210 was last updated).

The foregoing systems and methods allow for the complete data collected on a removable storage device 210 to be automatically transferred to a remote data storage server 354 using a transfer station 352 with minimal intervention by an operator. That is, the foregoing systems and methods enable and streamline the management and transfer of a high volume of sensor and system data stored recorded by an autonomous vehicle on high volume storage devices, e.g., removable storage devices 210, to a remote data storage server, such as a remote cloud storage lake.

Moreover, the removable storage devices 210 increase vehicle utilization by reducing the amount of downtime that would normally be incurred for high-volume data transfers. In this regard, the ease of removing and replacing the removable storage devices 210 improves the utilization of an autonomous vehicle fleet. Furthermore, the foregoing systems and methods allow for relatively inexpensive removable storage devices 210 to be over-provisioned instead of expensive autonomous vehicles. The removable storage devices 210 and the transfer stations 352 provide a scalable and redundant solution that can be deployed to support diverse truck fleets, as well as data transfers from various different on premise locations, which ensures the adaptability to different operational scales.

Some embodiments involve one or more operations and/or processes that are described herein as being performed automatically, e.g., without requiring operator input or instruction. It should be understood that, in some embodiments, such operations and processes could be performed manually or with some level of operator input or instruction without departing from the spirit or scope of the present disclosure.

Some embodiments involve the use of one or more electronic processing or computing devices. As used herein, the terms “processor” and “computer” and related terms, e.g., “processing device,” “computing device,” and “computing system,” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A transfer station for receiving a plurality of removable storage devices storing autonomous vehicle sensor data and transferring the autonomous vehicle sensor data to a remote data storage server, comprising:
a plurality of bays, each of the plurality of bays (i) including a port, and (ii) being configured to receive a removable storage device storing autonomous vehicle sensor data; and
a computing system, including:
a memory storing an authentication and decryption engine,
a physical server node, and
a processor in communication with the memory, the physical server node, and the port of each of the plurality of bays, the processor:
decrypting a removable storage device using the authentication and decryption engine upon connection of the removable storage device to a port of one of the plurality of bays,
authenticating the removable storage device using the authentication and decryption engine upon decryption of the removable storage device, and
transferring the autonomous vehicle sensor data stored on the removable storage device to a remote data storage server upon authenticating the removable storage device.

2. The transfer station of claim 1, wherein the processor transfers autonomous vehicle sensor data stored on each of a plurality of removable storage devices to the remote data storage server simultaneously upon decrypting and authenticating each of the plurality of removable storage devices.

3. The transfer station of claim 1, wherein the processor decrypts the removable storage device using a master key that is capable of decrypting a plurality of removable storage devices each having a different encryption key.

4. The transfer station of claim 3, wherein the master key is received by the computing system from a remote management system.

5. The transfer station of claim 1, wherein the processor authenticates the provenance of the autonomous vehicle sensor data stored on the removable storage device.

6. The transfer station of claim 1, wherein the processor automatically deletes the autonomous vehicle sensor data stored on the removable storage device upon confirming that all desired autonomous vehicle sensor data has been transferred to the remote data storage server.

7. The transfer station of claim 1, wherein the processor:
generates a manifest of desired files to be transferred from the removable storage device to the remote data storage server.

8. The transfer station of claim 1, wherein the autonomous vehicle sensor data includes a plurality of packets, each of the plurality of packets has a respective topic associated therewith, and the processor restricts the transferring of at least a portion of the autonomous vehicle sensor data from the removable storage device to the remote data storage server based on topic and/or the processor prioritizes the transfer of the autonomous vehicle sensor data from the removable storage device to the remote data storage server based on topic.

9. The transfer station of claim 1, wherein information relating to the transfer of the autonomous vehicle sensor data from the removable storage device to the remote data storage server including a status of the transfer is accessible by the computing system via a web interface.

10. The transfer station of claim 1, wherein the processor:
automatically decrypts the removable storage device using the authentication and decryption engine upon connection of the removable storage device to a port of one of the plurality of bays,
automatically authenticates the removable storage device using the authentication and decryption engine upon decryption of the removable storage device, and
automatically transfers the autonomous vehicle sensor data stored on the removable storage device to a remote data storage server upon authenticating the removable storage device.

11. A method of transferring autonomous vehicle sensor data stored on a removable storage device to a remote data storage server, comprising:
receiving, in a bay of a transfer station, a removable storage device containing autonomous vehicle sensor data;
determining that the removable storage device is in communication with a computing system of the transfer station via a port of the bay;
decrypting the removable storage device using an authentication and decryption engine of the computing system upon determining that the removable storage device is in communication with the computing system;
authenticating the removable storage device using the authentication and decryption engine upon decrypting the removable storage device; and
transferring the autonomous vehicle sensor data stored on the removable storage device to a remote data storage server upon authenticating the removable storage device.

12. The method of claim 11, comprising:
receiving, in a second bay of the transfer station, a second removable storage device containing second autonomous vehicle sensor data;
determining that the second removable storage device is in communication with the computing system via a second port of the second bay;
decrypting the second removable storage device using the authentication and decryption engine upon determining that the second removable storage device is in communication with the computing system;
authenticating the second removable storage device using the authentication and decryption engine upon decryption of the second removable storage device; and
transferring the second autonomous vehicle sensor data stored on the second removable storage device to the remote data storage server upon authenticating the second removable storage device.

13. The method of claim 12, wherein the autonomous vehicle sensor data and the second autonomous vehicle sensor data are transferred to the remote data storage server simultaneously.

14. The method of claim 11, wherein decrypting the removable storage device includes:
decrypting the removable storage device using a master key that is capable of decrypting a plurality of removable storage devices each having a different encryption key.

15. The method of claim 14, comprising:
receiving the master key at the computing system from a remote management source.

16. The method of claim 11, wherein authenticating the removable storage device includes:
authenticating the provenance of the autonomous vehicle sensor data stored on the removable storage device.

17. The method of claim 11, comprising:
confirming that all desired autonomous vehicle sensor data has been transferred to the remote data storage server; and
automatically deleting the autonomous vehicle sensor data stored on the removable storage device upon confirming that all desired autonomous vehicle sensor data has been transferred to the remote data storage server.

18. The method of claim 11, comprising:
generating a manifest of desired files to be transferred from the removable storage device to the remote data storage server;
generating an index of files transferred from the removable storage device to the remote data storage server; and
determining a transfer progress based on at least the manifest and the index.

19. The method of claim 11, comprising:
restricting the transferring of at least a portion of the autonomous vehicle sensor data from the removable storage device to the remote data storage server based on one or more topics associated with the autonomous vehicle sensor data; and/or
prioritizing the transferring of at least a portion of the autonomous vehicle sensor data from the removable storage device to the remote data storage server based on one or more topics associated with the autonomous vehicle sensor data.

20. The method of claim 11, comprising:
displaying information relating to the transfer of the autonomous vehicle sensor data from the removable storage device to the remote data storage server including a status of the transfer.

21. The method of claim 11, comprising:
removing the removable storage device from a port of an autonomous vehicle;
inserting the removable storage device into the bay of the transfer station; and
connecting a port of the removable storage device with the port of the bay.

22. The method of claim 11, wherein:
decrypting the removable storage device using an authentication and decryption engine of the computing system is performed automatically upon determining that the removable storage device is in communication with the computing system,
authenticating the removable storage device using the authentication and decryption engine is performed automatically upon decrypting the removable storage device, and
transferring the autonomous vehicle sensor data stored on the removable storage device to the remote data storage server is performed automatically upon authenticating the removable storage device.
